(19) United States
(12) Patent Application Publication
(10) Pub. No.: US 2008/0143112 A1
(43) Pub. Date: Jun. 19, 2008

(54) SMALL WIND-POWER SUPERCAPACITOR ENERGY STORAGE SYSTEM

(76) Inventor: Ming-Hsin SUN, Hsinchu County (TW)

Correspondence Address: Ming-Hsin SUN, 235 Chung - Ho, Box 8-24, Taipei, 235, omitted

(21) Appl. No.: 12/024,114

(22) Filed: Feb. 1, 2008

(30) Foreign Application Priority Data
Dec. 18, 2006 (TW) 095147545

(51) Int. Cl. H02P 9/04; F03D 9/00

(52) U.S. Cl. 290/44

(57) ABSTRACT

A small wind power supercapacitor energy storage system comprises a small wind-power generator for generating electric power from wind-power; a low internal-resistance power-storage supercapacitor for storing the electric power from the small wind-power generator and then for driving a load. The small electric power can be accumulated to have great electric power so as to drive LED lights or small electric power devices. The low internal resistance of a supercapacitor is used to get and accumulate small electric power from wind-power generator into large electric power so as to drive LED lights or small electric power devices. The efficiency of the system is better than solar power application and thus it provides great convenience and has a lower cost.

### FIELD OF THE INVENTION

The present invention relates to the energy storage system, and particularly to a small wind-power supercapacitor energy storage system, which comprises a small wind-power generator for generating electric energy from wind-power; a low internal resistance power type storage supercapacitor for catching storing electric power from the small wind-power generator and then for driving a load.

### BACKGROUND OF THE INVENTION

In the current renewable power, wind-power is more economic than solar power. However the wind speed must be greater than someone value for having being economic for power generation. The areas suitable for wind power generators are strictly confined. Most of wind-power generation is set up in valleys or beaches. But solar power energy is got in area with suffice sunlight.

The main concern for wind-power generators is that when the wind-power is small, the power from the generator is slight and is difficult to be used. In TW M287874 and Germany 202006003834.5, the smallest wind power generator in the world, only 0.15 W (2.4V, 70 mA) of power is generated, which can not be used in most of current used energy storage devices. The most important factor is that the internal resistance or ESR (equivalent series resistance) of the energy storage devices in charging and discharging process is too large, so the energy lose and heat produce is too high to use.

When the wind speed is greater than 3 m/sec, the wind power generator can work. Thus there are many places which are suitable for this limitation, but no proper small electric energy storage is provided. So the energy was wasted and ignored. However a low internal resistance supercapacitor energy storage device can catch, store and accumulate small electric power.

Small wind-power has a definition of the wind speed being between 3 to 12 m/sec. Generally, the wind out of an air conditioner is 7.8 m/sec. The wind speed of an electric fan is 3.8 m/sec. For storing electric power in low wind speed, batteries or energy releasing supercapacitors are suitable under the consideration of power efficiency.

The wind speed of small wind power is between 3 to 12 m/sec. We know that the wind speed out of an air conditioner is about 7.8 m/sec. And the wind speed of an electric fan is 3.8 m/sec. The power efficiency of the small wind power is insufficient under above these conditions by batteries or energy releasing supercapacitors.

The supercapacitor can be divided into two types, one is energy releasing supercapacitor, and the other is transient power supercapacitor. The character of former likes a battery, such as supercapacitors, electric double layer capacitors, metal capacitors, or high capacitance capacitors which store the physics property electric energy so as to have higher reliability and long lifetime than chemical batteries. The capacitance of these supercapacitors are several Faradays to several thousands Faradays. The other one, the transient power type supercapacitor with the like-capacitor character can provide very large power at a very short time, such as a flash supercapacitor. The power can be discharged transiently. The capacitance is only several micro Faradays or several Faradays, but it has a small internal resistance or ESR than a battery and the capacitance thereof is greater than ceramic capacitor or aluminum electrolytic capacitor.

In the following, we compare the supercapacitors of different manufacturers. The capacitances of the supercapacitors are between 40 to 60 mF with voltages between 5 to 6V, while the capacitor of Hiteck has an internal resistance of 130 mΩ, a very low value. In power transmission, the energy lose is very low.

The following tables show the capacitances and voltages for different kinds of supercapacitors.

| | | | | |
|---|---|---|---|---|
| 1 | Panasonic | EECF5R5U474 | 5.5 V, | ESR > 30Ω |
| | | (NF series) | 47 mF | |
| 2 | NEC/Tokin | FC0H473ZTBR24 | 5.5 V, 47 mF | ESR = 50Ω |
| 3 | Elna | DX-5R5 473 | 5.5 V, 47 mF | ESR = 120Ω |
| 4 | Hiteck(Taiwan) | 1912 | 6 V, 60 mF | ESR = |
| | | | | 130 mΩ |

As mentioned above, the supercapacitor must overcome the problem of high internal resistance to have higher efficient power transmission and storage. For a minimum wind-power generator currently used, it generates power of 0.15 W (2.4V, 70 mA), which cause the voltage decrements of

As mentioned above, the supercapacitor must overcome the problem of high internal resistance to have higher efficient energy catch and storage. For a miniature wind power generators currently used, it generates power of 0.15 W (2.4V, 70 mA), which cause the voltage drops of 2.1V, 3.5V, 8.4V and 0.0091V for above four manufacturers. The former three voltages of energy relaxing supercapacitors have over the generated voltage and thus the power cannot be caught and stored, but the voltage decrement for the Hiteck is only 0.1V. Thus power can be saved. In the present invention, the transient power storage supercapacitor is used as power primary storage capacitor so that small electric energy can be caught, stored, accumulated and operation.

For above four manufacturers. The former three voltages have over the generated voltage and thus the power cannot be stored, but the voltage decrement for the Hiteck is only 0.1V. Thus power can be saved. In the present invention, the transient power storage supercapacitor is used as power storage capacitor so that small electric power can be stored, accumulated and operation.

V=I×R=70 mA×ESR=2.1V, 3.5V, 8.4V, 0.0091V Summary of the invention

Accordingly, the primary object of the present invention is to provide a small wind-power storage supercapacitor system, which is especially used in small wind-power. The lower internal resistance can be used to store electric power. The small electric power is accumulated to have great electric power so as to drive LED lights or small electric power devices. The main concern of the present invention is to use the low internal resistance of a supercapacitor to accumulate small electric power from a wind-power generator into large electric power so as to drive LED lights or small positive electrode devices. The efficiency of the present invention is better than solar power application and the present invention can provide great convenience and has a lower cost.

### SUMMARY OF THE INVENTION

Accordingly, the primary object of the present invention is to provide a small wind-power storage energy supercapacitor system, which is especially used in small wind power device. The lower internal resistance of supercapacitors can be used to catch and store electric power. The small electric energy is accumulated to have huge electric power so as to drive LED lights or small electric power machine. The main concern of the present invention is to use the low internal resistance of a supercapacitor to catch and accumulate small electric power from a wind power generator into enormous electric power so as to drive LED lights or small electric power machine devices. The efficiency of the present invention is better than solar power application and the present invention can provide great convenience and the inexpensive cost.

The present invention provides three forms for storing electric power.

1. A transient power storage supercapacitor is used to catch and store energy. A low internal resistance power storage supercapacitor is used to catch and store electric energy from a wind power generator. The supercapacitor is used to drive a load directly. The driving time is related to the capacitance of the supercapacitor.

2. A transient power storage supercapacitor is used to catch and store electric power. When energy is sufficient, the energy is transferred to a secondary battery for storage. The system can work in a long time period. The load is driven by a secondary battery or the transient power storage supercapacitor directly.

3. A transient power storage supercapacitor is used to catch and store electric power. When energy is sufficient, the energy is transferred to an energy relaxing type supercapacitor which likes a battery. The energy relaxing supercapacitor is such as a double layer capacitor, a gold capacitor, a high capacity capacitor or an electric chemical capacitor. The load is driven by the energy relaxing type supercapacitor or the transient power storage supercapacitor directly.

In the present invention, the electric energy is used in the following fields.

1. The stored energy is used for lighting up yellow light LEDs, or red light LEDs, or green light LEDs for alerting, or driving low voltage LEDs or mechanical devices.

2. The voltage from the transient power storage supercapacitor is boosted to a higher voltage and accumulated to a large current for driving a load. Moreover, it can drive white light high power LEDs or signal transmitters.

There are three ways of the present invention for using electric energy.

1. The small wind power supercapacitor energy storage system is used as only one electric energy source.

2. The small wind power supercapacitor energy storage system is combined with a commercial wind power generating system. When the wind power device is large, the present invention is incorporated into a wind power generating system. When wind speed is small, it is switched to the small wind power supercapacitor energy storage system for storing power.

3. The small wind power supercapacitor energy storage system is incorporated with other power, such as combined with a solar power generating system, a flywheel power generating system, or the other renewable energy system.

The present invention can be used to a wind power LED traffic alarm light, a wind power LED night light, a climate monitoring device, a detector, a signal transmitter, a seawater desalting machine, a positioning transmitter, a small power machine, or a non-continuous electric power machine.

To achieve above objects, the present invention provides a small wind power supercapacitor energy storage system, comprising: a small wind power generator for generating electric energy; a low internal resistance power storage supercapacitor for catching and storing the electric energy from the small wind power generator and then for driving a load; the battery or energy releasing type supercapacitor will storage larger the electric energy. The various objects and advantages of the present invention will be more readily understood from the following detailed description when read in conjunction with the appended drawing.

The various objects and advantages of the present invention will be more readily understood from the following detailed description when read in conjunction with the appended drawing.

### BRIEF DESCRIPTION OF DRAWINGS

FIG. 1 shows the first embodiment of the present invention.

FIG. 2 shows the second embodiment of the present invention.

FIG. 3 shows the third embodiment of the present invention.

FIG. 4 shows the first application of the present invention.

FIG. 5 shows the second application of the present invention.

FIG. 6 shows three systems for the further applications of the present invention.

### DETAIL DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

In the following, the small wind power supercapacitor energy storage system of the present invention will be described.

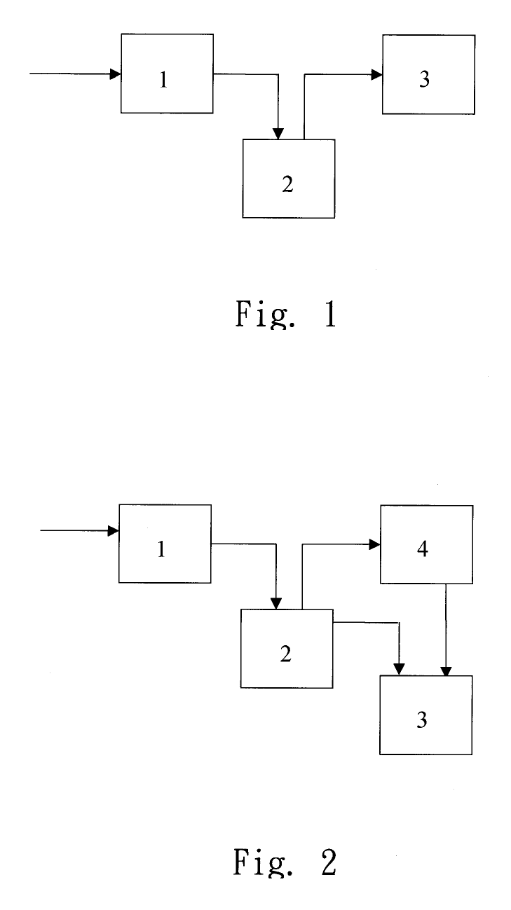

Referring to FIG. 1, the first energy storage system of the present invention is illustrated. The system has a small wind power generator 1 for generating electric energy from wind-power. A low internal resistance power type supercapacitor 2 serves for catching and accumulating the electric energy from the small wind power generator 1 and then for driving a load 3. The high resistance battery or energy releasing supercapacitor will consume much energy. The low internal resistance power storage supercapacitor 2 is a suitable one for this system.

With referring to FIG. 2, the second energy storage system of the present invention is illustrated. The system has a small wind power generator 1 for generating electric energy from wind-power. A low-internal resistance power type supercapacitor 2 is used. When electric energy is caught and accumulated in the low internal resistance power type supercapacitor 2 to have a enormous power, a secondary battery 4 serves to receive the electric energy from the low-internal resistance power type supercapacitor 2 for driving a load 3. The secondary battery 4 may be one of a rechargeable battery, such as a Nickel hydrogen battery, a Lithium battery, or a lead acid battery etc. Besides, when the energy charge of the secondary battery 4 is saturated, the energy charged to the secondary battery 4 must be slow for avoiding energy waste due to the chemical reaction of the battery material. In this embodiment, the low internal resistance power type supercapacitor 2 can supply power to the load 3 directly. Thus the energy capacity of the secondary battery 4 can be reduced. When the secondary battery 4 drives the load 3, the voltage of the secondary battery 4 will decrease gradually and finally it is lower than that of the load 3. At this moment, the secondary battery 4 and the low internal resistance power type supercapacitor 2 are connected in parallel for driving the load 3. Not only as an energy catcher and accumulator, the low internal resistance power type supercapacitor 2 is also used as a second energy storage source in the discharge process.

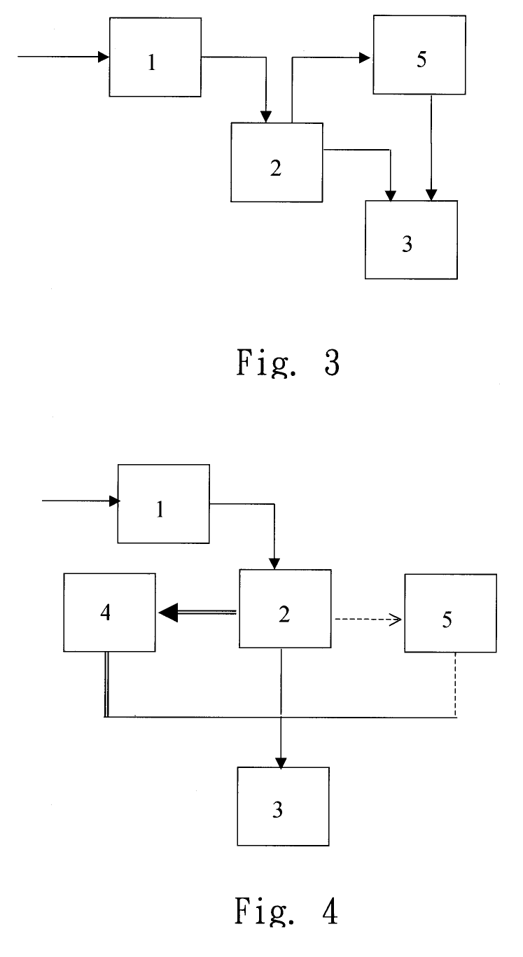

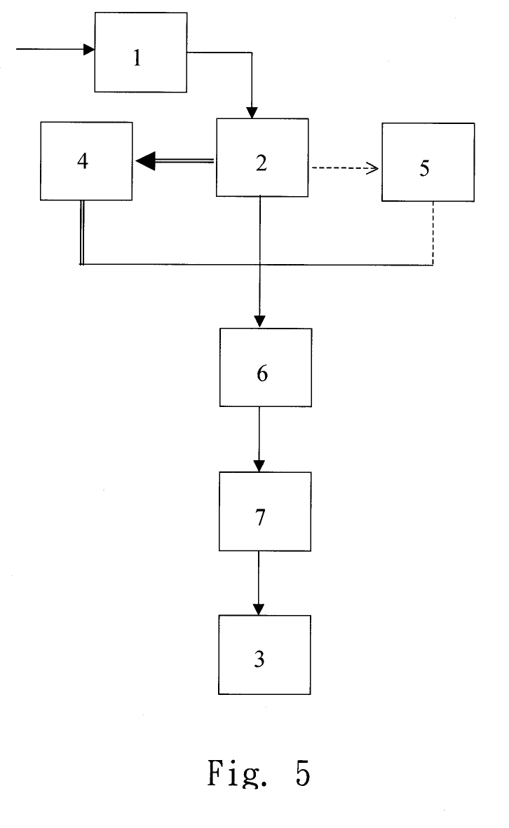

With referring to FIG. 3, the third energy storage system of the present invention is illustrated. The system has a small wind power generator 1 for generating electric power from wind-power and a low internal resistance power type supercapacitor 2. Electric energy is caught and accumulated in the low internal resistance power type supercapacitor 2 to have a enormous power. An energy releasing supercapacitor 5 serves to receive the electric energy from the low internal resistance power type supercapacitor 2 for driving a load 3. The energy releasing supercapacitor 5 is used as a main and larger energy source which can stores energy for very long time and drive a load for a long time. Since an internal resistance of the energy releasing supercapacitor 5 is lower than that of the secondary battery 4, the efficiency of the energy releasing supercapacitor 5 is greater than that of the secondary battery 4.

Referring to FIG. 4, because the electric energy in the electric circuit is presented by voltage or current, the driving voltage must be higher than the voltage of the load for working. In the system of FIG. 1, as the wind power is smaller, a voltage generated by the small wind-power generator 1 is smaller than 12V, often only 2 to 3V. The voltage of the low internal resistance power type supercapacitor 2 is slightly smaller than that of a wind-power generator. The storage energy system only drives a load 3 of small voltage, such as LEDs for lighting up yellow light LEDs, or red light LEDs, or green light LEDs for alerting. Moreover, the electric power can be stored in the secondary battery 4 or energy releasing supercapacitor 5 as those illustrated in FIGS. 2 and 3.

As above mentioned system, the voltages of systems in FIGS. 1, 2 and 3 are low and thus it is not suitable for driving high voltage devices, such as white light LEDs. Thus, the low internal resistance power type supercapacitor 2, secondary battery 4 and energy releasing supercapacitor 5 are connected to a voltage boost converter 6 for increasing the voltages. Then the voltage boost converter 6 is connected to a supercapacitor 7 for accumulating and increasing current for driving a load 3.

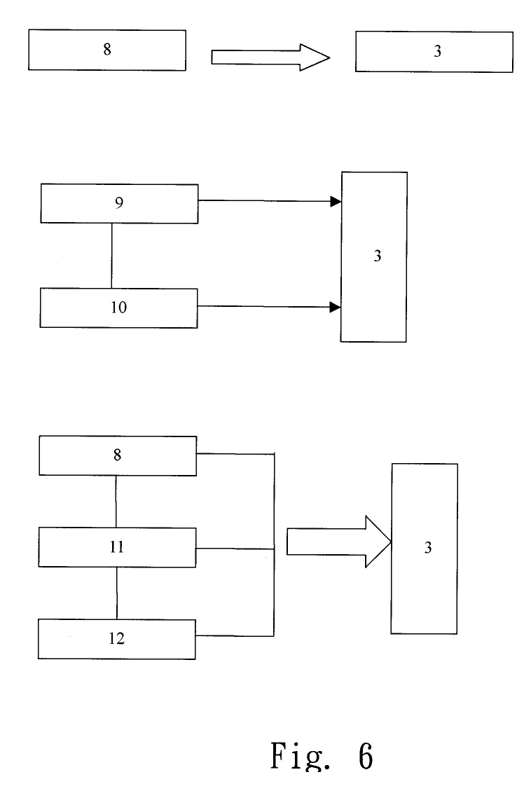

Referring to FIG. 6, for the first operation way of the present invention, a small wind power storage supercapacitor system 8 singly drives a load 3. At this moment, other energy storage system, batteries, cannot catch and store electric energy due to larger internal resistance.

For the second operation way of the present invention, a composite wind power generating system is used. When wind speed is great, a large wind-power generator 10 will generate electric energy. When wind speed is slight, the small wind-power storage supercapacitor system 9 is used to catch and store electric power. The large wind-power generator system and small wind-power storage supercapacitor system 9 can drive the load 3 singly or together.

For the third operation way of the present invention, a small wind-power storage supercapacitor system 8, a solar power generating system 11 and a flywheel power generator 12 are connected in parallel to drive a load 3.

The present invention can be used to a wind-power LED traffic alarm light, a wind-power LED night light, a climate monitoring device, a detector, a signal transmitter, a seawater desalting machine, a positioning transmitter, a small electric power machine, or a non-continuous electric power machine,

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A small wind power supercapacitor energy storage system, comprising:
a small wind power generator for generating electric power,
a low ESR (equivalent series resistance) power supercapacitor for storing the electric power from the small wind power and accumulating the lower power to huge energy. Then the energy system drives a load.

2. The small wind power supercapacitor energy storage system as claimed in claim 1, wherein the load is one of a wind-power LED traffic alarm light, a wind-power LED night light, a climate monitoring device, a detector, a signal transmitter, a seawater desalting machine, a positioning transmitter, a small power machine, micro-electromechnical system and a non-continuous electric power machine.

3. The small wind power supercapacitor energy storage system as claimed in claim 1, wherein the power or energy storage supercapacitor is one of high energy density, high power density supercapacitors, electric double layer capacitors, ultracapacitors, carbon supercapacitors, golden supercapacitors, polymer supercapacitors, metal oxide supercapacitors, and aluminum electrolytic capacitors, special in ruthenium dioxide supercapacitors.

4. The small wind power supercapacitor energy storage system as claimed in claim 1, wherein the power or energy storage supercapacitor is connected to a secondary battery and the load; the power or energy storage supercapacitor stores and accumulate small electric energy and then transfers the energy to the secondary battery for driving the load.

5. The small wind power supercapacitor energy storage system as claimed in claim 4, wherein the secondary battery is selected from one of a Nickel hydrogen battery, a Lithium battery, a lead acid battery and rechargeable batteries.

6. The small wind power supercapacitor energy storage system as claimed in claim 1, wherein the power or energy storage supercapacitor is connected to a energy releasing supercapacitor and a load as a small wind power storage device, when enormous power is accumulated therein, then the power is stored to the energy releasing supercapacitor. Then the energy system drive a load.

7. The small wind power supercapacitor energy storage system as claimed in claim 6, wherein the power releasing supercapacitor is selected from one of a golden capacitor, ultracapacitors, electric double layer capacitors, carbon supercapacitors, electrochemical capacitors, and aluminum electrolytic capacitors.

8. The small wind power supercapacitor energy storage system as claimed in claim 6, wherein the energy releasing supercapacitor is connected to a secondary battery which is further connected to the another power supercapacitor.

9. The small wind power supercapacitor energy storage system as claimed in claim 8, wherein a voltage-boosting converter is connected between a power supercapacitor and a load; the booster is connected to a supercapacitor which is then connected to the load.

10. The small wind power supercapacitor energy storage system as claimed in claim 9, wherein the Buck-Boost converter includes a voltage Buck-Boost converter and other voltage booster circuit.

11. The small wind power supercapacitor energy storage system as claimed in claim 1, wherein the system is connected to one of a larger scale wind-power generator, a solar power generator system, a flywheel power generator system and the combination thereof.

12. The small wind power supercapacitor energy storage system as claimed in claim 1, wherein the power supercapacitor is a transient power supercapacitor.
